(19) United States
(12) Patent Application Publication
(10) Pub. No.: US 2016/0085433 A1
(43) Pub. Date: Mar. 24, 2016

(54) Apparatus and Method for Displaying Preference for Contents in Electronic Device

(71) Applicant: Samsung Electronics Co., Ltd., Suwon-si (KR)

(72) Inventors: Won-Jae LEE, Seongnam-si (KR); Ja-Kyoung LEE, Seoul (KR); Kyoung-Ae KIM, Seoul (KR); Hee-Jung KIM, Seongnam-si (KR); Yoon-Jung CHOI, Seongnam-si (KR)

(21) Appl. No.: 14/862,827

(22) Filed: Sep. 23, 2015

(30) Foreign Application Priority Data
Sep. 23, 2014 (KR) 10-2014-0126714

(51) Int. Cl. G06F 3/0484; G06F 3/16; G06F 3/0483

(52) U.S. Cl. CPC G06F 3/04847; G06F 3/0483; G06F 3/165

(57) ABSTRACT

A method of operating an electronic device includes receiving preference information about each of a plurality of sub-contents constituting contents, from a second electronic device, and displaying a preference for each of the plurality of sub-contents based on the preference information.

### RELATED APPLICATION(S)

This application claims priority under 35 U.S.C. §119(a) to Korean Patent Application Serial No. 10-2014-0126714, which was filed in the Korean Intellectual Property Office on Sep. 23, 2014, the entire content of which is incorporated herein by reference.

### BACKGROUND

The present disclosure relates to a technology for a service providing contents in an electronic device.

The growth of communication technologies leads to a rapid increase of the propagation of user equipment. The increasing propagation of the user equipment brings about an increase of the demand for contents services through the user equipment as well. According to this, the central media of the contents services are changing from the existing newspaper, magazine, book, Television (TV), radio, etc. to the user equipment. According to this, contents service providers are making endeavors in order for contents consumers to use the contents services with more convenience through the user equipment.

### SUMMARY

An exemplary embodiment of the present disclosure is to provide an apparatus and method for displaying a preference for each of a plurality of sub-contents constituting contents in an electronic device.

Another exemplary embodiment of the present disclosure is to provide an apparatus and method for displaying a preference for each of a plurality of contents within a digital magazine in an electronic device.

A further exemplary embodiment of the present disclosure is to provide an apparatus and method for displaying in color a preference for each of a plurality of contents within a digital magazine in an electronic device.

A yet another exemplary embodiment of the present disclosure is to provide an apparatus and method for displaying in a timeline or thumbnail form a preference for each of a plurality of contents within a digital magazine in an electronic device.

An electronic device according to an exemplary embodiment of the present disclosure includes a communication unit for receiving preference information about each of a plurality of sub-contents constituting contents, from a second electronic device, and a display unit for displaying a preference for each of the plurality of sub-contents based on the preference information.

An electronic device according to an exemplary embodiment of the present disclosure includes a reception unit for receiving viewing information about each of a plurality of sub-contents constituting contents, from at least one second electronic device, and a transmission unit for transmitting preference information about each of the plurality of sub-contents to the at least one second electronic device.

An operation method of an electronic device according to an exemplary embodiment of the present disclosure includes receiving preference information about each of a plurality of sub-contents constituting contents, from a second electronic device, and displaying a preference for each of the plurality of sub-contents based on the preference information.

An operation method of an electronic device according to an exemplary embodiment of the present disclosure includes receiving viewing information about each of a plurality of sub-contents constituting contents, from at least one second electronic device, and transmitting preference information about each of the plurality of sub-contents to the at least one second electronic device.

### BRIEF DESCRIPTION OF THE DRAWINGS

The above and other objects, features and advantages of the present disclosure will become more apparent from the following detailed description when taken in conjunction with the accompanying drawings in which:

FIG. 1 illustrates a network environment including an electronic device according to various exemplary embodiments of the present disclosure;

FIG. 2 illustrates an example of acquiring information about a preference for contents in an electronic device according to various exemplary embodiments of the present disclosure;

FIG. 3A through FIG. 3C illustrate examples of displaying information about a preference for contents in an electronic device according to various exemplary embodiments of the present disclosure;

FIG. 4A through FIG. 4D illustrate other examples of displaying a preference for contents in an electronic device according to various exemplary embodiments of the present invention;

FIG. 5 illustrates an example of an operation procedure of an electronic device according to various exemplary embodiments of the present disclosure;

FIG. 6 illustrates another example of an operation procedure of an electronic device according to various exemplary embodiments of the present disclosure;

FIG. 7 illustrates an example of a block construction of an electronic device according to various exemplary embodiments of the present disclosure; and

FIG. 8 illustrates an example of a block construction of a program module according to various exemplary embodiments of the present disclosure.

### DETAILED DESCRIPTION

Hereinafter, embodiments of the present disclosure are described in detail with reference to the accompanying drawings. Those of ordinary skill in the art will recognize that various changes and modifications of the embodiments described herein can be made without departing from the scope of the present disclosure. In addition, descriptions of well-known functions and constructions may be omitted for clarity and conciseness. The same reference symbols are used throughout the drawings to refer to the same or like parts.

Expressions such as “include” or “may include” that may be used in the present disclosure indicate existence of a disclosed relevant function, operation, or element, etc., and do not limit additional one or more functions, operations, or elements, etc. Also, it should be understood that terms such as “include” or “have” in the present disclosure are intended for designating the existence of a characteristic, a number, a step, an operation, an element, a part, or a combination thereof described in this disclosure and do not exclude in advance the existence or additional possibility of one or more other characteristics, numbers, steps, operations, elements, parts, or a combination thereof.

An expression such as “or”, etc. in the present disclosure includes a certain and all combinations of words listed together. For example, “A or B” may include A and may include B, or include both A and B.

In the present disclosure, expressions such as “1st”, “2nd”, “first” or “second”, etc. may modify various elements of the present disclosure but do not limit relevant elements. For example, these expressions do not limit sequence and/or importance, etc. of relevant elements. The expressions may be used for distinguishing one element from another element. For example, both a first user apparatus and a second user apparatus are all user apparatuses, and represent different user apparatuses. For example, a first element may be referred to as a second element, and similarly, the second element may be referred to as the first element.

When it is mentioned that a certain element is “connected to” or “accesses” another element, it should be understood that the element may be directly connected to another element or may directly access another element, but still another element may exist in the middle. In contrast, when it is mentioned that a certain element is “directly connected to” or “directly accesses” another element, it should be understood that still another element does not exist in the middle.

Terminology used in the present disclosure is used for explaining a specific embodiment and is not intended for limiting the present disclosure. Unless clearly expressed otherwise, expression of the singular includes expression of the plural.

Unless defined differently, all terminologies used herein including technological or scientific terminologies have the same meaning as that generally understood by a person of ordinary skill in the art to which the present disclosure belongs. It should be understood that generally used terminologies defined by a dictionary have meanings consistent with meanings of a related technology, and unless clearly defined in the present disclosure, they are not understood as an ideal or excessively formal meaning.

The term “module” as used herein may be defined as, for example, a unit including a combination of one or two or more among a hardware, a software, or a firmware. The term “module” may be interchangeably used with the phrase unit, logic, a logical block, a component, or a circuit, etc. A “module” may be a minimum unit of an integrally configured part or a portion thereof. A “module” may be a minimum unit performing one or more functions or a portion thereof. A “module” may be mechanically or electronically implemented. For example, a “module” according to the present disclosure may include at least one of an Application-Specific Integrated Circuit (ASIC) chip, a Field-Programmable Gate Arrays (FPGAs), or a programmable-logic device which are known, or to be developed in the future, and performing certain operations.

An electronic device according to the present disclosure may be a device including a communication function. For example, an electronic device may include at least one of, but is not limited to, a smartphone, a tablet personal computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, or a wearable device (e.g., a head-mounted-device (HMD) such as electronic glasses, an electronic clothing, an electronic bracelet, an electronic necklace, an electronic appcessory, an electronic tattoo, or a smartwatch).

The electronic device may be a smart home appliance having a communication function. A smart home appliance may include, but is not limited to, at least one of a television, a Digital Video Disc (DVD) player, an audio, a refrigerator, an air conditioner, a cleaner, an oven, an electronic range, a washing machine, an air purifier, a set-top box, a TV box (e.g., Samsung HomeSync®, Apple TV®, or Google TV®), game consoles, an electronic dictionary, an electronic key, a camcorder, or an electronic frame.

The electronic device may include, but is not limited to, at least one of various medical devices (e.g., Magnetic Resonance Angiography (MRA), Magnetic Resonance Imaging (MRI), Computed Tomography (CT), a shooting device, an ultrasonic device, etc.), a navigation device, a Global Positioning System (GPS) receiver, an event data recorder (EDR), a flight data recorder (FDR), an automobile infotainment device, electronic equipment for a ship (e.g., a navigation device for a ship, a gyro compass, etc.), avionics, a security device, or a robot for an industrial use or a home use.

The electronic device may include, but is not limited to, at least one of furniture or a portion of a building/structure including a communication function, an electronic board, an electronic signature receiving device, a projector, or various measurement devices (e.g., waterworks, electricity, gas, or radio wave measuring device, etc.). The electronic device may be a combination of one or more of the above-described devices. Also, the electronic device is not limited to the above-described devices.

Hereinafter, an electronic device is described with reference to the accompanying drawings. A user as described herein may indicate a person who uses an electronic device or a device (e.g., an artificial intelligence electronic device) that uses the electronic device.

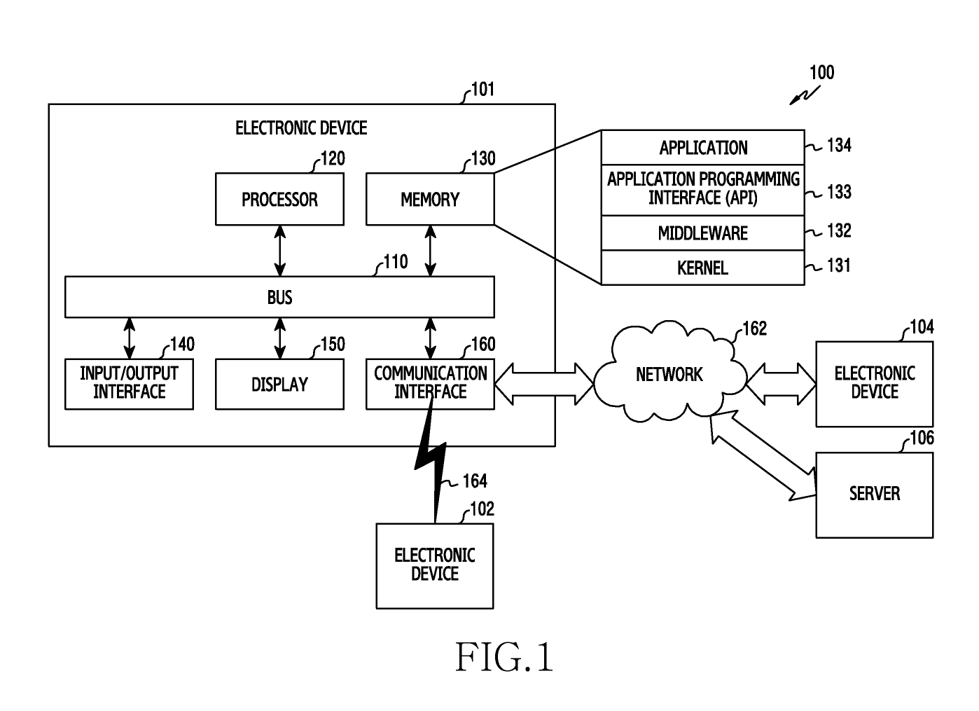

FIG. 1A is a diagram illustrating a network environment 100 including an electronic device 101, according to an embodiment of the present disclosure.

Referring to FIG. 1, the electronic device 101 includes a bus 110, a processor 120, a memory 130, an input/output (I/O) interface 150, a display 160, and a communication interface 170.

The bus 110 may be a circuit for connecting the above-described elements with each other, and transferring communication (e.g., a control message) between the above-described elements.

The processor 120 may include a Central Processing Unit (CPU), a Communication Processor (CP), a Graphic Processing Unit (GPU).

The processor 120 receives, for example, an instruction from the above-described other elements (e.g., the memory 130, the I/O interface 150, the display 160, or the communication interface 170, etc.) via the bus 110, deciphers the received instruction, and executes an operation or a data process corresponding to the deciphered instruction.

The memory 130 stores an instruction or data received from the processor 120 or other elements (e.g., the I/O interface 150, the display 160, or the communication interface 170, etc.), or generated by the processor 120 or other elements. The memory 130 includes, for example, programming modules 140, such as a kernel 131, a middleware 132, an application programming interface (API) 133, or an application 134. Each of the programming modules may be configured using software, firmware, hardware, or a combination of two or more of these devices.

The kernel 131 controls or manages system resources (e.g., the bus 110, the processor 120, or the memory 130, etc.) used for executing an operation or a function implemented in the rest of the programming modules, for example, the middleware 132, the API 133, or the application 134. Also, the kernel 131 provides an interface for allowing the middleware 132, the API 133, or the application 134 to access an individual element of the electronic device 101, and controls or manages the same.

The middleware 132 performs a mediation role so that the API 133 and/or the application 134 may communicate with the kernel 131, e.g., to transmit and receive data. Also, in connection with task requests received from the application 134, the middleware 132 may perform a control (e.g., scheduling or load balancing) for, or generate a task request using, for example, a method of assigning priority that may use a system resource of the electronic device 101 to at least one application 134.

The API 133 is an interface for allowing the application 134 to control a function provided by the kernel 131 or the middleware 132, and may include at least one interface or function (e.g., an instruction) for file control, window control, image processing, or character control, etc.

The application 134 may include a Short Message Service/Multimedia Messaging Service SMS/MMS application, an e-mail application, a calendar application, alarm application, a health care application (e.g., an application for measuring quantity of motion or blood sugar, etc.), or an environment information application (e.g., an application providing atmospheric pressure, humidity or temperature information, etc.). Additionally or alternatively, the application 134 may be an application related to information exchange between the electronic device 101 and an external electronic device (e.g., the electronic device 102 or 104). The application 134 related to the information exchange may include, for example, a notification relay application for transferring specific information to the external electronic device or a device management application for managing the external electronic device.

For example, the notification relay application may include a function for transferring notification information generated from a different application (e.g., an SMS/MMS application, an e-mail application, a health care application, or an environment information application) of the electronic device 101 to the external the electronic device 102 or 104. Additionally or alternatively, the notification relay application may, for example, receive notification information from the external electronic device 102 or 104 and provide the same to a user.

The device management application may manage (e.g., install, delete, or update) functions of the external electronic device 102 or 104 that communicates with the electronic device 101. Some exemplary functions may include turning on/off of the external electronic device 102 or 104, or some constituent parts of the external electronic device 102 or 104. Other exemplary functions may include luminance and/or resolution control of a display of the external electronic device 102 or 104. Still other exemplary functions may include an application operating in the external electronic device 102 or 104, or a service, such as, for example, a communication service or a message service provided by the external electronic device 102 or 104.

The application 134 may include a designated application depending on an attribute (e.g., a kind of an electronic device) of the external electronic device 104. For example, in the case where the external electronic device is an MP3 player, the application 134 may include an application related to music reproduction. Similarly, in the case where the external electronic device is a mobile medical health care device, the application 134 may include an application related to healthcare. The application 134 may include at least one of an application designated in the electronic device 101 and an application received from the external electronic device (e.g., a server 106, the electronic devices 102 or 104).

The I/O interface 150 transfers an instruction or data input from a user via an I/O unit (e.g., a sensor (not shown), a keyboard (not shown), or a touchscreen (not shown)) to the processor 120, the memory 130, or the communication interface 170 via the bus 110. For example, the I/O interface 150 provides data regarding a user's touch input via the touchscreen to the processor 120. Also, the I/O interface 150 may, for example, output an instruction or data received via the bus 110 from the processor 120, the memory 130, or the communication interface 170 via the I/O unit (e.g., a speaker or a display). For example, the I/O interface 150 outputs voice data processed by the processor 120 to a user via a speaker (not shown).

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 displays various types of contents (e.g., text, images, videos, icons, and/or symbols) to users. The display 160 may include a touch screen, and may receive, for example, a touch, gesture, proximity, or hovering input by using an electronic pen or a part of the user's body.

The display 160 may display a contact list based on a priority of each of the contacts included in the contact list. For example, the priority of the contacts may be determined based on at least one of a transmission history, a transmission frequency, a transmission speed, a charging policy, intimacy, a counterpart's location, a schedule, and/or application preference.

The display 160 may display a service list based on a priority of each of the applications 134 or services included in the service list. For example, the priority of the applications 134 or services may be determined based on configuration information of a service provider, configuration information of a manufacturer, contact information, application preference, user preference, a use time, a distance from a target to share contents, a transmission history, and a charging policy.

The communication interface 170 provides communication between the electronic device 101 and the external device 104 106. For example, the communication interface 170 may be connected to a network 162 through wireless communication or wired communication, and may communicate with the external device 104 or the server 106.

The wireless communication may use at least one of, for example, Long Term Evolution (LTE), Long Term Evolution-Advance (LTE-A), Code Division Multiple Access (CDMA), Wideband Code Division Multiple Access (WCDMA), Universal Mobile Telecommunications System (UMTS), WiBro (Wireless Broadband), and Global System for Mobile Communications (GSM) as a cellular communication protocol.

The wireless communication may include at least one of, for example, WiFi®, Bluetooth®, BLE, Zigbee®, Infrared (IR) communication, and ultrasonic communication as a short-range communication protocol 164.

The wired communication may include, for example, at least one of Universal Serial Bus (USB), High Definition Multimedia Interface (HDMI), Recommended Standard 232 (RS-232), and Plain Old telephone Service (POTS).

The network 162 may include at least one of a computer network (e.g., a LAN or a WAN), the Internet, and a telephone network.

The electronic devices 102 and 104 may be devices of the same type as that the electronic device 101 or devices of different types from that of the electronic device 101. The server 106 may include a group of one or more servers (not shown). All or some of the operations executed in the electronic device 101 may be carried out in one or more of second electronic devices, such as, for example, the external devices 102 and 104, and the server 106. When the electronic device 101 is required to perform functions or services automatically or upon request, the electronic device 101 may make a request for performing some or all of the functions related to the requested functions or services to one or more of the second electronic devices, such as the electronic devices 102 and 104, and/or the server 106, instead of carrying out the requested functions or services. The electronic device 102, 104, or 106 may carry out the functions requested by the electronic device 101 or additional functions, and provide results thereof to the electronic device 101. The electronic device 101 may provide the requested functions or services to the second electronic device based on the received results or after additionally processing the received results. To this end, for example, cloud computing, distributed computing, or client-server computing technology may be used by the electronic device 101.

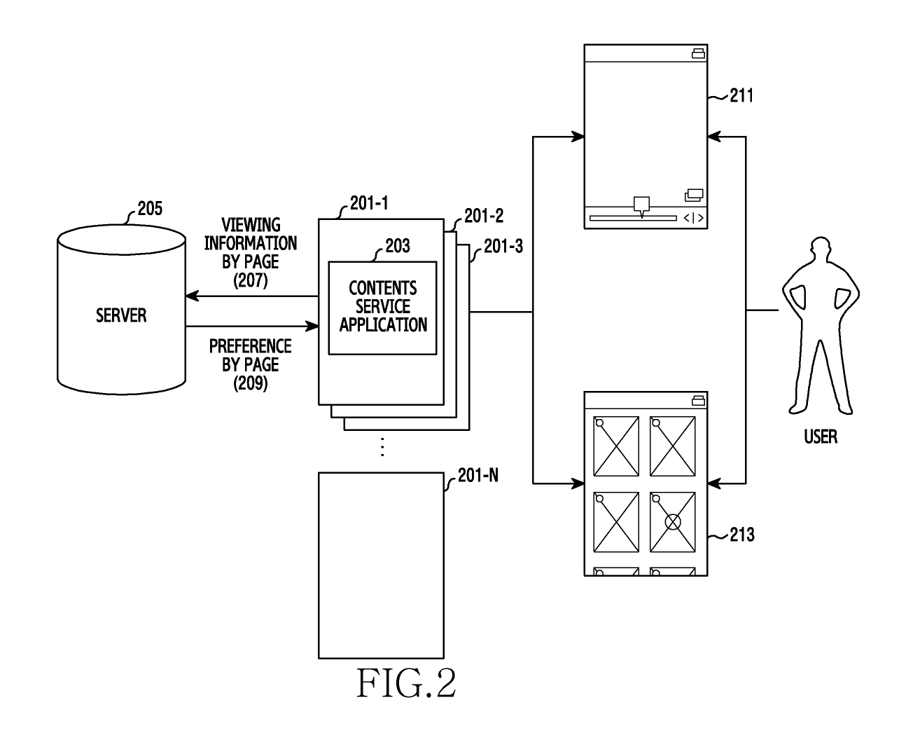

FIG. 2 illustrates an example of acquiring information about a preference for contents in an electronic device 201-1 (e.g., similar to the electronic device 101) according to various exemplary embodiments of the present disclosure.

Referring to FIG. 2, the electronic device 201-1 may include a contents service application 203. Also, each of a plurality of electronic devices 201-1 through 201-N(N≧2) may also include the contents service application 203. The contents service application 203 may check information of contents use of a user of the electronic device 201-1.

In accordance with an exemplary embodiment of the present disclosure, the contents service application 203 may provide a magazine service. For example, the contents service application 203 may provide a service of allowing the user to view a digital magazine consisting of a plurality of sections and/or pages. It should be understood that the contents service application 203 may provide a service of allowing the user to view more than one digital magazine. For example, the digital magazine may be stored in the electronic device 201-1 or a second electronic device, for example, the electronic devices 102, 104, 106 of FIG. 1.

At this time, the contents service application 203 may check whether the user has viewed any of the sections and/or pages of the digital magazine. In other words, the contents service application 203 may check user's viewing information about each of a plurality of sections and/or pages constituting the digital magazine. The contents service application 203 may transmit the user's viewing information 207 of the plurality of sections and/or pages to a server 205. In some embodiments, viewing information 207 may include, for example, pages of the digital magazine read. The server 205 may be managed by a contents service provider (not shown) that provides the contents service application 203.

In accordance with an exemplary embodiment of the present disclosure, the server 205 may receive the viewing information from the plurality of electronic devices 201-1 to 201-N each including the contents service application 203.

The server 205 may generate information about a user preference defined by page of the digital magazine based on the respective viewing information 207 by page received from the plurality of electronic devices 201-1 to 201-N. In other words, the server 205 may generate information about levels at which the user views the respective pages of the digital magazine. The server 205 may generate preference information 209 by page and transmit the preference information 209 by page to the plurality of electronic devices 201-1 to 201-N.

The electronic device 201-1 may display in a timeline form 211 or a thumbnail form 213 a preference for each of the plurality of sections or pages constituting the digital magazine based on the preference information 209 by page received from the server 205.

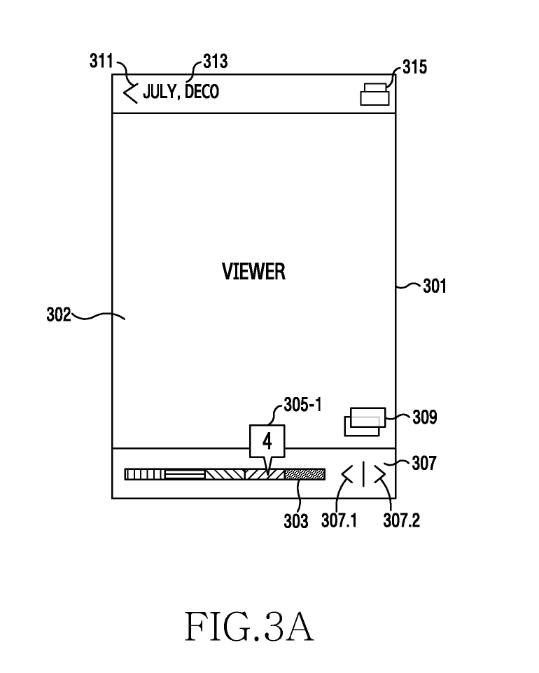

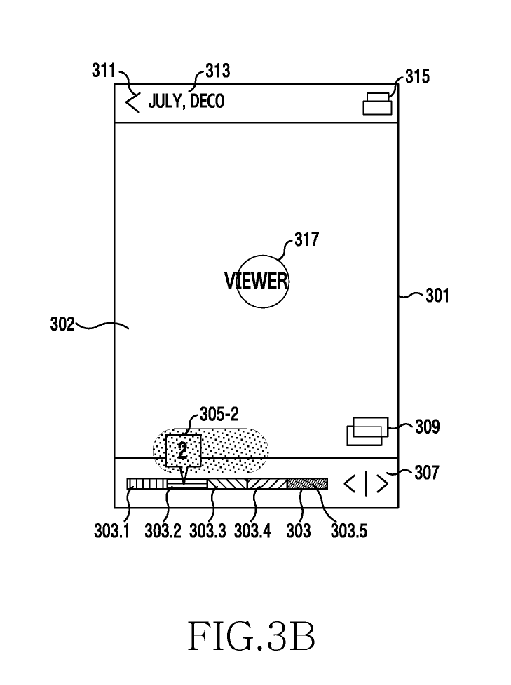

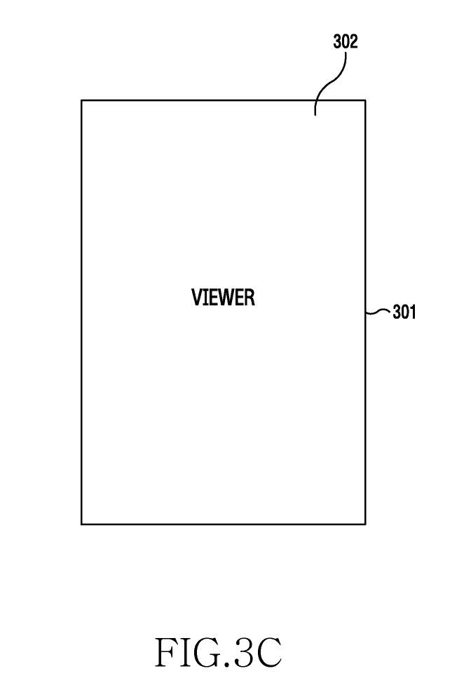

FIG. 3A through FIG. 3C illustrate examples of displaying information about a preference for contents in an electronic device according to various exemplary embodiments of the present disclosure.

Referring to FIG. 3A, the electronic device 301 may display via a screen 302 a user preference for each of a plurality of pages constituting at least one magazine that a user may view through a contents service application (e.g., the contents service application 203 of FIG. 2). In accordance with an exemplary embodiment of the present disclosure, the electronic device 301 may display the user preference for each of the plurality of pages, in color. For example, the electronic device 301 may display the user preference through a timeline 303 in which colors matching with the user preferences for the plurality of pages are displayed.

In accordance with another exemplary embodiment of the present disclosure, the plurality of pages may be a plurality of HyperText Markup Languages (HTMLs).

For example, in case that a rate of a user viewing a page 4 of the at least one magazine among users viewing the at least one magazine is equal to or is greater than 80%, the electronic device 301 may display a timeline 303 portion corresponding to the page 4 in red corresponding to the best preference.

In case that a rate of a user viewing a page 2 of the at least one magazine among the users viewing the at least one magazine is equal to or is greater than 30% and is less than 50%, the electronic device 301 may display a timeline 303 portion corresponding to the page 2 in yellow corresponding to a second-grade preference.

Also, the electronic device 301 may display an indicator for indicating which portion of the timeline 303 matches with a currently viewed page. For example, the electronic device 301 may display a page indicator 305-1 indicating the timeline 303 portion corresponding to the page 4. For example, the page indicator 305-1 may include a numeral 4 representing a page number of the page 4.

For example, the color matching with the user preference may be given as in Table 1 below.

TABLE 1

| Preference | Color |
|---|---|
| Best (equal to or greater than 80%) | Red |
| First grade (equal to or greater than 50% and less than 80% | Orange |
| Second grade (equal to or greater than 30% and less than 50%) | Yellow |
| Third grade (equal to or greater than 10% and less than 30%) | Green |
| Least (less than 10%) | Blue |

The electronic device 301 may display a page turning tab 307. For example, the electronic device 301 may turn a page of the magazine through a user's touch input to the page turning tab 307. For example, in case that the electronic device 301 outputs a page 4 of the magazine, if the user touches a back tab icon “<” 307.1 of the page turning tab 307, the electronic device 301 may display a page 3. Also, if the user touches a forward tab icon “>” 307.2 of the page turning tab 307, the electronic device 301 may output a page 5.

The electronic device 301 may display a scrap information icon 309 for the magazine. The electronic device 301 may make a scrap portion of at least one page of the magazine. Also, the electronic device 301 may store scrap information about the at least one page. If the electronic device 301 senses a touch input at the scrap information icon 309 from a user, the electronic device 301 may display information about the scrap portion that the user has made from the magazine.

The electronic device 301 may display a page list display icon 311. If the electronic device 301 senses a touch input at the page list display icon 311 from a user, the electronic device 301 may display through the screen 302 a list of pages of the magazine.

The electronic device 301 may also display summary information 313 of the magazine. For example, the electronic device 301 may display information such as a publication date of the magazine, a name of the magazine, and a category name of a currently viewed page.

The electronic device 301 may display a magazine selection icon 315. For example, if the electronic device 301 senses a touch input at the magazine selection icon 315 from a user, the electronic device 301 may display through the screen 302 a list of other available magazines currently not being viewed.

In accordance with another exemplary embodiment of the present disclosure, the electronic device 301 may display less than all of the page turning tab 307, the scrap information icon 309, the page list display icon 311, the summary information 313, and the magazine selection icon 315.

Referring to FIG. 3B, the user may turn a page by means of a page indicator 305-2. For example, if the electronic device 301 senses a touch-and-drag input at the page indicator 305-2 from a user, the electronic device 301 may display on the screen 302 a page corresponding to the touch-and-drag input of the user. For example, in case that the electronic device 301 displays a page 4 of the magazine, the user may touch-and-drag the page indicator 305-1 indicating the page 4 (of FIG. 3A) and move the page indicator 305-1 to page 2. At this time, the electronic device 301 may display the page indicator 305-2 indicating a timeline 303 portion corresponding to the page 2. Also, the electronic device 301 may thus display on the screen 302 page 2 of the magazine.

In FIG. 3A and FIG. 3B, the timeline 303 displays only preferences for 5 pages 303.1 through 303.5. In other embodiments, the timeline 303 may display preferences for other number of pages in accordance with another exemplary embodiment of the present disclosure.

If the user touches any one portion 317 of the screen 302 outputting the magazine, the electronic device 301 may optionally and/or selectively hide at least one of the timeline 303, the page indicator 305-2, the page turning tab 307, the scrap information icon 309, the page list display icon 311, the summary information 313, and the magazine selection icon 315.

For example, if a user touches any one portion 317 of the screen 302, the electronic device 301 may, as illustrated in FIG. 3C, display only a page text of the magazine, except the timeline 303, the page indicator 305-2, the page turning tab 307, the scrap information icon 309, the page list display icon 311, the summary information 313, and the magazine selection icon 315.

In accordance with another exemplary embodiment of the present disclosure, the contents may be a video or a sound file. For example, the electronic device 301 may display a preference for each of an arbitrarily defined plurality of sections of the video. For example, in case that a playback time period of the video is 60 seconds, the electronic device 301 may divide the video in the unit of 10 seconds and display preferences for the respective units. For example, the electronic device 301 may display a preference for a section of 1 second to 10 seconds of the video, a preference for a section of 11 seconds to 20 seconds, a preference for a section of 21 seconds to 30 seconds, a preference for a section of 31 seconds to 40 seconds, a preference for a section of 41 seconds to 50 seconds, and a preference for a section of 51 seconds to 60 seconds, respectively. For instance, if a current playback time point of the video is included in the section of 1 second to 10 seconds, the electronic device 301 may display a playback time point icon (not shown) in a color matching with the preference for the section of 1 second to 10 seconds.

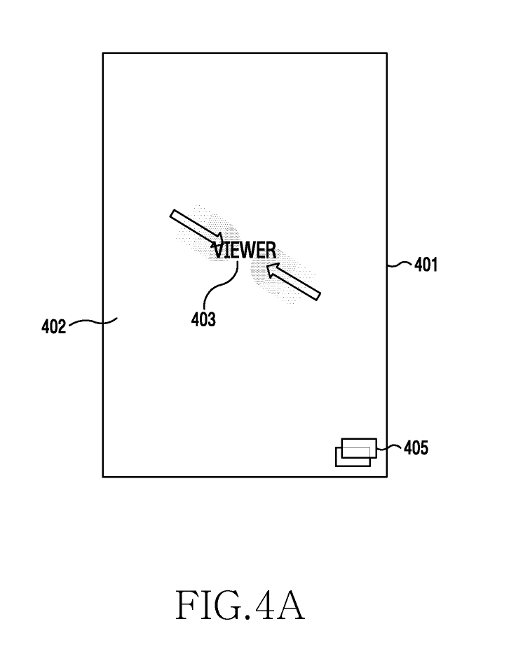

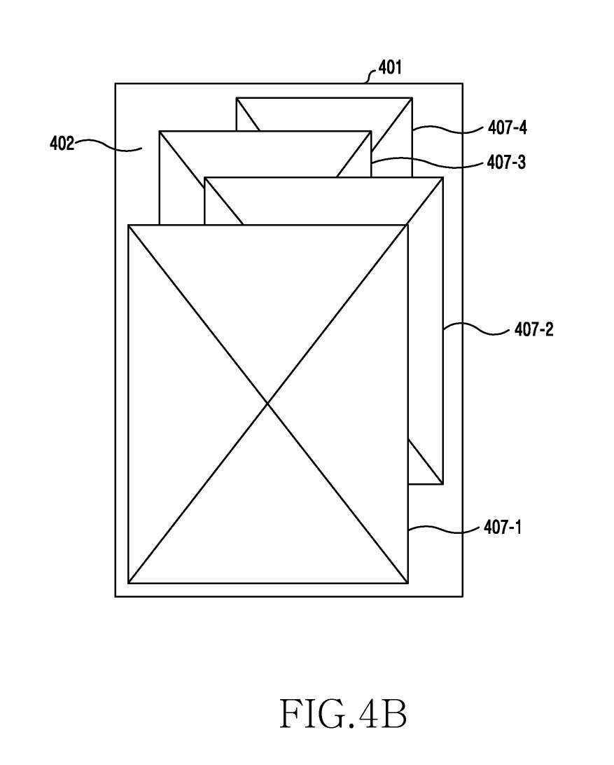

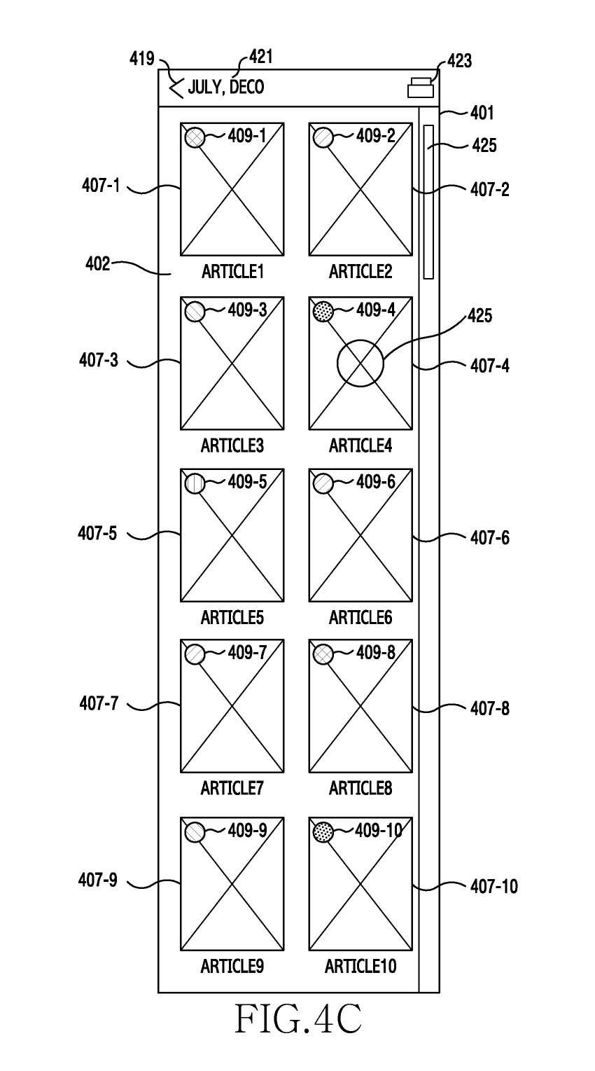

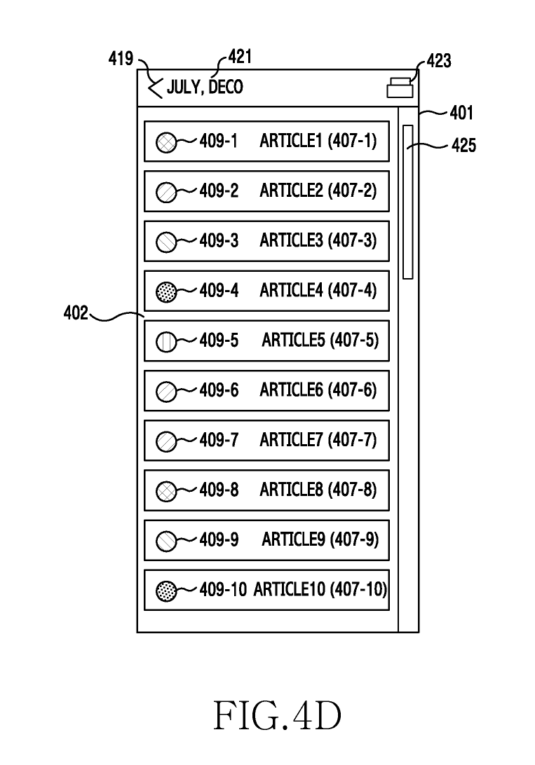

FIG. 4A to FIG. 4D illustrate other examples of displaying a preference for contents in an electronic device according to various exemplary embodiments of the present disclosure.

Referring to FIG. 4A, the electronic device 401 may display on a touch screen 402 a list of preferences for contents. For example, the electronic device 401 may display items indicating preferences for respective pages of at least one magazine.

For example, the electronic device 401 may display at least one page among the respective pages. The electronic device 401 may recognize a pinch input 403 at the touch screen 402—indicating two different inputs are converging towards each other. If the touch screen 402 recognizes a pinch input 403, the electronic device 401 may display on the screen 402 items indicating the preferences for the respective pages.

For example, referring to FIG. 4B, in accordance with the pinch input 403, the electronic device 401 may reduce a size of a page 407-1 outputted to the screen 402 of the electronic device 401. At this time, in a state of reducing the size of the page 407-1 outputted to the screen 402, if the pinch input 403 is ended, i.e., if the touch input from a user is no longer sensed, the electronic device 401 may display on the screen 402 reducing at least one size among the size of the outputted pages 407-1 through 407-4 of the magazine.

Referring to FIG. 4C, the electronic device 401 may display via the screen 402 a plurality of pages of the magazine in a thumbnail scheme. The thumbnail scheme may include a scheme of reducing sizes of the plurality of pages and outputting the reduced pages to the screen 402 in order for a user to examine the whole layout of the plurality of pages.

For example, the electronic device 401 may reduce the pages 407-1 to 407-4 to a predefined size in accordance with the pinch input 403 and then, align the reduced pages 407-1 to 407-4 in a predefined scheme. At this time, the electronic device 401 may reduce even other pages 407-5 to 407-10 of the magazine to the predefined size together with the pages 407-1 to 407-4 and then, align the reduced pages 407-1 to 407-10 in the predefined scheme.

In accordance with an exemplary embodiment of the present disclosure, the electronic device 401 may display a preference for each of the plurality of pages 407-1 to 407-10. For example, the electronic device 401 may display color matching preferences 409-1 through 409-10 of the pages 407-1 to 407-10. The color matching with the preference is given as in Table 1 above. If the electronic device 402 senses a touch input at any one of the plurality of pages 407-1 to 407-10, the electronic device 401 may magnify the selected or touched page.

In accordance with another exemplary embodiment of the present disclosure, the position and size of the color matching preferences 409-1 through 409-10 may be different. In accordance with a further exemplary embodiment of the present disclosure, a scheme of aligning the plurality of pages 407-1 to 407-10 may be different. For example, the electronic device 401 may align the plurality of pages 407-1 to 407-10 in a list form, rather than a thumbnail scheme.

For example, referring to FIG. 4D, the electronic device 401 may display the color matching preferences 409-1 through 409-10 as a list including articles 407-1 through 407-10. If the user selects at least one of the lists 407-1 to 407-10 of the plurality of pages, the electronic device 401 may magnify and display a page of the selected list.

In accordance with a further exemplary embodiment of the present disclosure, the contents may be a video or a sound file, rather than a magazine. For example, in case that the contents are the video, the electronic device 401 may display a preference for each of a plurality of sections constituting the video. For example, in case that the contents are contents of a movie, the electronic device 401 may display a preference for each of a plurality of scenes constituting the movie.

According to various exemplary embodiments, an electronic device may include

a communication unit configured to receive preference information about each of a plurality of sub-contents constituting contents, from a second electronic device, a display unit configured to display a preference for each of the plurality of sub-contents based on the preference information.

According to various exemplary embodiments, the display unit may display the preference for each of the plurality of sub-contents in a color matching with the preference.

According to various exemplary embodiments, the display unit may display a position of each of the plurality of sub-contents on a User Interface (UI) for searching the contents, and displays a preference matching with the position of each of the plurality of sub-contents on the UI.

According to various exemplary embodiments, the display unit may align and display items of the respective plurality of sub-contents whose preferences are displayed.

According to various exemplary embodiments, the display unit may align and display the items in at least one of a thumbnail form and a list form.

According to various exemplary embodiments, the contents may be contents of a digital magazine, and the plurality of sub-contents may be a plurality of pages constituting the digital magazine.

According to various exemplary embodiments, the contents may be at least one of a video and a sound file, and the plurality of sub-contents may be an arbitrarily divided plurality of sections constituting the at least one of a video and a sound file.

According to various exemplary embodiments, the communication unit may transmit viewing information about each of the plurality of sub-contents, to the second electronic device.

According to various exemplary embodiments, an electronic device may include a reception unit configured to receive viewing information about each of a plurality of sub-contents constituting contents, from at least one second electronic device, a transmission unit configured to transmit preference information about each of the plurality of sub-contents to the at least one second electronic device.

According to various exemplary embodiments, the electronic device may further include a control unit for generating the preference information on the basis of the viewing information.

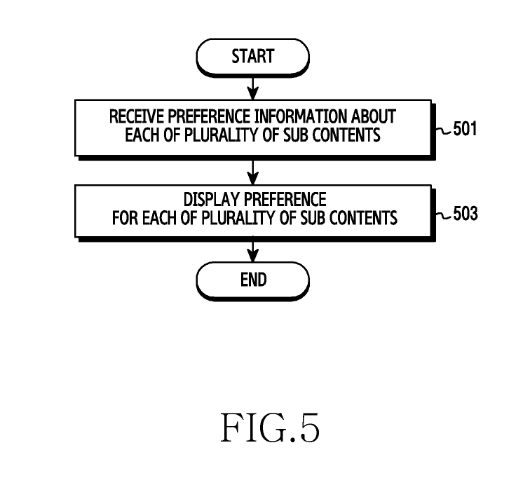

FIG. 5 illustrates an example of an operation procedure of an electronic device (e.g., the electronic device 101 of FIG. 1) according to various exemplary embodiments of the present disclosure.

Referring to FIG. 5, the electronic device may proceed to step 501 and receive preference information about each of a plurality of sub-contents. The electronic device may receive the preference information about each of the plurality of sub-contents constituting contents, from a second electronic device. In accordance with an exemplary embodiment of the present disclosure, the contents may be contents of a digital magazine, and the plurality of sub-contents may be a plurality of pages constituting the digital magazine. In accordance with another exemplary embodiment of the present disclosure, the contents may be at least one of a video and a sound file, and the plurality of sub-contents may be an arbitrarily defined plurality of sections constituting the at least one of a video and a sound file. The electronic device may transmit viewing information about each of the plurality of sub-contents, to the second electronic device.

The electronic device may proceed to step 503 and display a preference for each of the plurality of sub-contents. On the basis of the preference information, the electronic device may display the preference for each of the plurality of sub-contents. The electronic device may display the preference for each of the plurality of sub-contents in a color matching with the preference. The electronic device may display a position of each of the plurality of sub-contents on a User Interface (UI) for searching the contents, and display a preference matching with the position of each of the plurality of sub-contents on the UI. The electronic device may align an item of each of the plurality of sub-contents whose preferences are displayed, in a predefined scheme. The electronic device may align the items in at least one of a thumbnail form and a list form. The electronic device may transmit viewing information about each of the plurality of sub-contents, to a second electronic device.

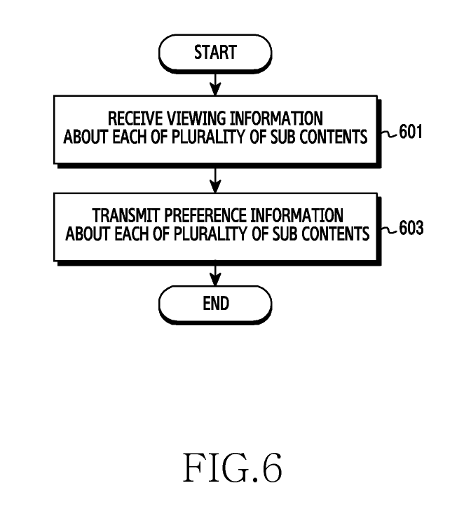

FIG. 6 illustrates another example of an operation procedure of an electronic device (e.g., the electronic device 101 of FIG. 1) according to various exemplary embodiments of the present disclosure.

Referring to FIG. 6, the electronic device may proceed to step 601 and receive viewing information about each of a plurality of sub-contents. The electronic device may receive the viewing information about each of the plurality of sub-contents constituting contents, from at least one second electronic device (e.g., the electronic device 102 of FIG. 1).

The electronic device may proceed to step 603 and transmit preference information about each of the plurality of sub-contents. The electronic device may transmit the preference information about each of the plurality of sub-contents, to the at least one second electronic device. The electronic device may generate the preference information based on the viewing information.

According to various exemplary embodiments, an operation method of an electronic device may include receiving preference information about each of a plurality of sub-contents constituting contents from a second electronic device, displaying a preference for each of the plurality of sub-contents based on the preference information.

According to various exemplary embodiments, the displaying of the preference may include displaying the preference for each of the plurality of sub-contents in a color matching with the preference.

According to various exemplary embodiments, displaying of the preference may further include displaying a position of each of the plurality of sub-contents on a User Interface (UI) for searching the contents, displaying a preference matching with the position of each of the plurality of sub-contents on the UI.

According to various exemplary embodiments, the displaying of the preference may align and display items of the respective plurality of sub-contents whose preferences are displayed.

According to various exemplary embodiments, the displaying of the preference may align and display the items in at least one of a thumbnail form and a list form.

According to various exemplary embodiments, the contents may be contents of a digital magazine, and the plurality of sub-contents may be a plurality of pages constituting the digital magazine.

According to various exemplary embodiments, the contents may be at least one of a video and a sound file, and the plurality of sub-contents may be an arbitrarily divided plurality of sections constituting the at least one of a video and a sound file.

According to various exemplary embodiments, the operation method of an electronic device may further include transmitting viewing information about each of the plurality of sub-contents, to the second electronic device.

According to various exemplary embodiments, an operation method of an electronic device may include receiving viewing information about each of a plurality of sub-contents constituting contents, from at least one second electronic device, transmitting preference information about each of the plurality of sub-contents to the at least one second electronic device.

According to various exemplary embodiments, the operation method of an electronic device may further include generating the preference information based on the viewing information.

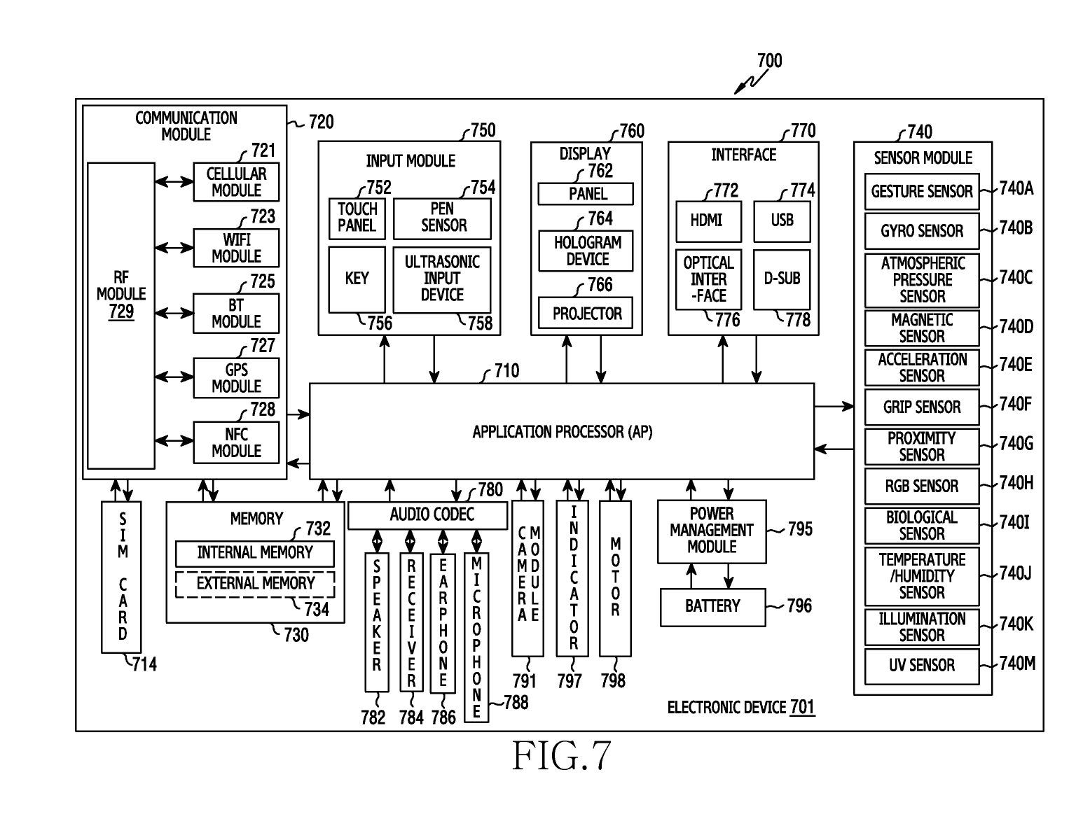

FIG. 7 is a diagram 700 illustrating an electronic device 701, according to an embodiment of the present disclosure. The electronic device 701 may include at least some of the components of the electronic device 101 illustrated in FIG. 1.

Referring to FIG. 7, the electronic device 701 may include one or more application processors (AP) 710, a communication module 720, a subscriber identification module (SIM) card 724, a memory 730, a sensor module 740, an input unit 750, a display 760, an interface 770, an audio module 780, a camera module 791, a power management module 795, a battery 796, an indicator 797, or a motor 798.

The AP 710 drives an OS or an application to control a plurality of hardware or software elements connected to the AP 710 and performs various data processes including multimedia data and operations. The AP 710 may be implemented, for example, as a System on Chip (SoC). The AP 710 may further include a Graphic Processing Unit (GPU).

The communication module 720 (e.g., the communication interface 160) performs data transmission/reception in communication between the electronic device 701 and other electronic devices (e.g., the electronic devices 102, 104 or the server 106) connected via the network 162. The communication module 720 includes a cellular module 721, a Wi-Fi® module 723, a BT module 725, a GPS module 727, an NFC module 728, and a Radio Frequency (RF) module 729.

The cellular module 721 provides voice communication, image communication, a short message service, or an Internet service, etc. via a communication network (e.g., LTE, LTE-A, CDMA, WCDMA, UMTS, WiBro, or GSM, etc.). Also, the cellular module 721 may perform discrimination and authentication of an electronic device within a communication network using, for example, a Subscriber Identify Module (e.g., a SIM card 724). The cellular module 721 may perform at least a portion of functions that may be provided by the AP 710. For example, the cellular module 721 may perform at least a portion of a multimedia control function.

The cellular module 721 may include a CP. Also, the cellular module 721 may be, for example, implemented as a SoC. Though elements such as the cellular module 721 (e.g., a communication processor), the memory 730, or the power management module 795, etc. are illustrated as elements separated from the AP 710 in FIG. 7, the AP 710 may be implemented to include at least a portion (e.g., the cellular module 721) of the above-described elements.

The AP 710 or the cellular module 721 (e.g., a communication processor) may load an instruction or data received from at least one of a non-volatile memory and other elements connected thereto onto a volatile memory, and process the same. Also, the AP 710 or the cellular module 721 may store data received from at least one of other elements or generated by at least one of other elements in a non-volatile memory.

Each of the Wi-Fi® module 723, the BT module 725, the GPS module 727, or the NFC module 728 may include, for example, a processor for processing data transmitted/received via a relevant module. Though the cellular module 721, the Wi-Fi® module 723, the BT module 725, the GPS module 727, or the NFC module 728 are illustrated as separate blocks in FIG. 7, at least a portion (e.g., two or more elements) of the cellular module 721, the Wi-Fi® module 723, the BT module 725, the GPS module 727, or the NFC module 728 may be included in one Integrated Circuit (IC) or an IC package. For example, at least a portion (e.g., a communication processor corresponding to the cellular module 721 and a Wi-Fi® processor corresponding to the Wi-Fi® module 723) of processors corresponding to each of the cellular module 721, the Wi-Fi® module 723, the BT module 725, the GPS module 727, or the NFC module 728 may be implemented as one SoC.

The RF module 729 performs transmission/reception of data, for example, transmission/reception of an RF signal. The RF module 729 may include, for example, a transceiver, a Power Amp Module (PAM), a frequency filter, or a Low Noise Amplifier (LNA), etc. Also, the RF module 729 may further include a part for transmitting/receiving an electromagnetic wave on a free space in wireless communication, for example, a conductor or a conducting line, etc. Though FIG. 7 illustrates the cellular module 721, the Wi-Fi® module 723, the BT module 725, the GPS module 727, and the NFC module 728 sharing one RF module 729, at least one of the cellular module 721, the Wi-Fi® module 723, the BT module 725, the GPS module 727, or the NFC module 728 may perform transmission/reception of an RF signal via a separate RF module.

The SIM card 724 may be inserted into a slot formed in a specific position of the electronic device 701. The SIM card 224 may include unique identify information (e.g., Integrated Circuit Card Identifier (ICCID)) or subscriber information (e.g., International Mobile Subscriber Identity (IMSI)).

The memory 730 (e.g., the memory 130) includes a built-in memory 732 or an external memory 734. The built-in memory 732 may include, for example, at least one of a volatile memory (e.g., Dynamic RAM (DRAM), Static RAM (SRAM), Synchronous Dynamic RAM (SDRAM)) and a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, NOR flash memory, etc.).

The built-in memory 732 may be a Solid State Drive (SSD). The external memory 734 may further include a flash drive, for example, Compact Flash (CF), Secure Digital (SD), Micro Secure Digital (Micro-SD), Mini Secure Digital (Mini-SD), extreme Digital (xD), or a memory stick. The external memory 734 may be functionally connected with the electronic device 701 via various interfaces. The electronic device 701 may further include a storage device (or a storage medium) such as a hard drive.

The sensor module 740 measures a physical quantity or detects an operation state of the electronic device 701 and converts the measured or detected information to an electric signal. The sensor module 740 includes, for example, at least one of a gesture sensor 740A, a gyro sensor 740B, an atmospheric pressure sensor 740C, a magnetic sensor 740D, an acceleration sensor 740E, a grip sensor 740F, a proximity sensor 740G, a color sensor 740H (e.g., red, green, blue (RGB) sensor), a living body sensor 740I, a temperature/humidity sensor 740J, an illumination sensor 740K, or an Ultra Violet (UV) sensor 740M. Additionally or alternatively, the sensor module 740 may include, for example, an E-nose sensor, an electromyography (EMG) sensor (not shown), an electroencephalogram (EEG) sensor (not shown), an electrocardiogram (ECG) sensor (not shown), an infrared (IR) sensor (not shown), an iris sensor (not shown), or a fingerprint sensor (not shown), etc. The sensor module 740 may further include a control circuit for controlling at least one sensor belonging thereto.

The input unit 750 may include a touch panel 752, a (digital) pen sensor 754, a key 756, or an ultrasonic input unit 758. The touch panel 752 recognizes a touch input using at least one of capacitive, resistive, infrared, or ultrasonic methods. Also, the touch panel 752 may further include a control circuit. A capacitive touch panel may perform detection by a physical contact or proximity recognition. The touch panel 752 may further include a tactile layer. In this case, the touch panel 752 may provide a tactile reaction to a user.

The (digital) pen sensor 754 may be implemented using, for example, a method which is the same as or similar to receiving a user's touch input, or using a separate sheet for detection. The key 756 may include, for example, a physical button, an optical key or keypad. The ultrasonic input unit 758 is a unit for recognizing data by detecting a sound wave using a microphone 788 in the electronic device 701 via an input tool generating an ultrasonic signal, and enables wireless recognition. The electronic device 701 receives a user input from an external device (e.g., a computer or a server 106) connected to the communication module 720 using the communication module 720.

The display 760 (e.g., the display 150) includes a panel 762, a hologram device 764, or a projector 766. The panel 762 may be, for example, a Liquid Crystal Display (LCD), or an Active-Matrix Organic Light-Emitting Diode (AM-OLED), etc. The panel 762 may be implemented, for example, such that it is flexible, transparent, or wearable. The panel 762 may be configured as one module together with the touch panel 252. The hologram device 764 may project a three-dimensional image in the air using interferences of light. The projector 766 may project light onto a screen to display an image. The screen may be positioned, for example, inside or outside the electronic device 701. The display 760 may further include a control circuit for controlling the panel 262, the hologram device 764, or the projector 766.

The interface 770 includes, for example, a High-Definition Multimedia Interface (HDMI) 272, a Universal Serial Bus (USB) 774, an optical interface 776, or a D-subminiature (D-sub) 778. The interface 770 may be included, for example, in the communication interface 160 illustrated in FIG. 1A. Additionally or alternatively, the interface 770 may include, for example, a Mobile High-definition Link (MHL) interface, a Secure Digital (SD) card/Multi-Media Card (MMC) interface, or an Infrared Data Association (IrDA) standard interface.

The audio module 780 may convert a sound and an electric signal in dual directions. At least a partial element of the audio module 780 may be included, for example, in the I/O interface 150 illustrated in FIG. 1A. The audio module 780 processes sound information input or output via, for example, a speaker 782, a receiver 784, an earphone 786, or the microphone 788, etc.

The camera module 791 is a device that may capture a still image and a moving picture. T camera module 791 may include one or more image sensors (e.g., a front sensor or a rear sensor), a lens, an Image Signal Processor (ISP), or a flash (e.g., an LED or xenon lamp).

The power management module 795 may manage power of the electronic device 701. The power management module 795 may include, for example, a Power Management Integrated Circuit (PMIC), a charger Integrated Circuit (IC), or a battery or a battery gauge.

The PMIC may be mounted, for example, inside an integrated circuit or a SoC semiconductor. A charging method may be classified into a wired charging method and a wireless charging method. The charging IC charges a battery and prevents introduction of an overvoltage and/or an overcurrent from a charger. The charging IC includes a charging IC for at least one of the wired charging method and the wireless charging method. The wireless charging method may be, for example, a magnetic resonance method, a magnetic induction method, or an electromagnetic wave method, etc., and may additionally include an additional circuit for wireless charging, for example, a circuit such as a coil loop, a resonance circuit, or a rectifier, etc.

The battery gauge measures, for example, a charge of the battery 796, a voltage, a current, or a temperature of the battery while charging the battery. The battery 796 stores or generates electricity, and supplies power to the electronic device 701 using the stored or generated electricity. The battery 796 may include, for example, a rechargeable battery or a solar battery.

The indicator 797 displays a specific state of the electronic device 701 or a portion thereof (e.g., the AP 710), for example, a booting state, a message state, or a charging state, etc. The motor 798 converts an electric signal to mechanical vibration. The electronic device 701 includes a processor (e.g., a GPU) for supporting a mobile TV. The processor for supporting the mobile TV may process media data corresponding to standards, for example, such as Digital Multimedia Broadcasting (DMB), Digital Video Broadcasting (DVB), or a media flow, etc.

Each of the aforementioned constitutional elements of the electronic device according to various exemplary embodiments of the present disclosure may consist of one or more components, and names thereof may vary depending on a type of electronic device. The electronic device according to various exemplary embodiments of the present disclosure may include at least one of the aforementioned constitutional elements. Some of the constitutional elements may be omitted, or additional other constitutional elements may be further included. In addition, some of the constitutional elements of the electronic device according to various exemplary embodiments of the present disclosure may be combined and constructed as one entity, so as to equally perform functions of corresponding constitutional elements before combination.

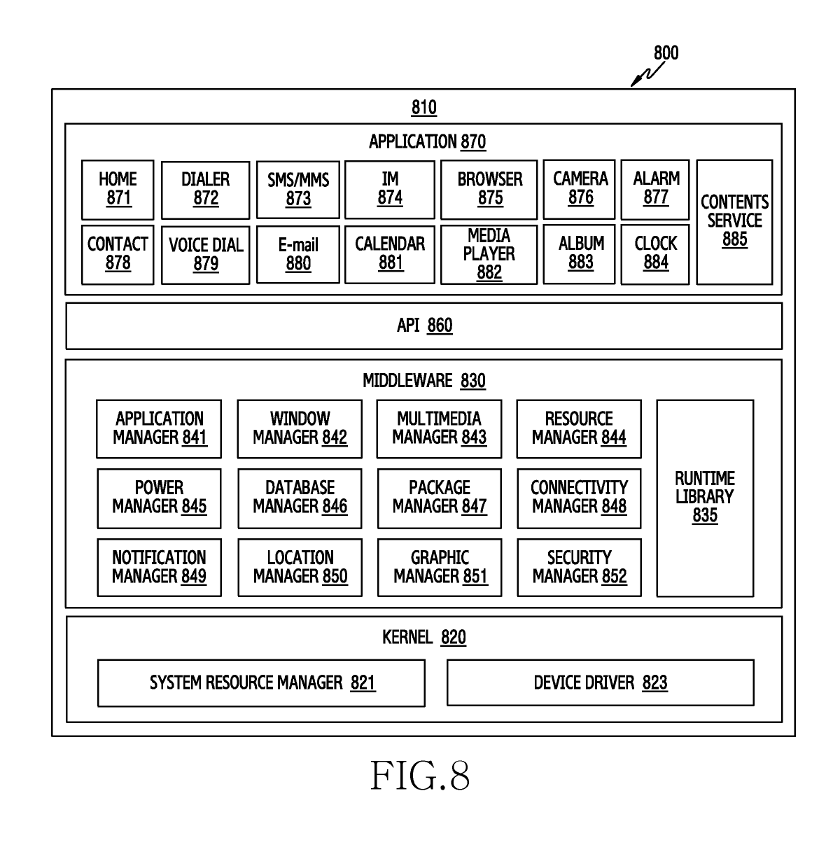

FIG. 8 is a diagram 800 of a program module 810, according to an embodiment of the present disclosure.

The program module 810 may include an OS for controlling resources related to the electronic device (e.g., the electronic devices 101 of FIG. 1) and/or various applications (e.g., the application programs 134) executed in the OS. The OS may be, for example, Android®, iOS®, Windows®, Symbian®, Tizen®, Bada®, or the like.

The programming module 810 includes a kernel 820, middleware 830, an API 860, and/or applications 870. At least some of the program module 810 may be preloaded in the electronic device or downloaded from the server.

The kernel 820 may include, for example, a system resource manager 831 or a device driver 823. The system resource manager 331 controls, allocates, or collects the system resources. The system resource manager 821 may include a process management unit, a memory management unit, or a file system management unit. The device driver 823 may include, for example, a display driver, a camera driver, a Bluetooth® driver, a shared-memory driver, a USB driver, a keypad driver, a WiFi® driver, an audio driver, or an Inter-Process Communication (IPC) driver.

The middleware 830 provides a function required by the applications 870 in common or provides various functions to the applications 870 through the API 860 so that the applications 870 can efficiently use limited system resources within the electronic device. The middleware 830 includes, for example, at least one of a runtime library 835, an application manager 841, a window manager 842, a multimedia manager 843, a resource manager 844, a power manager 845, a database manager 846, a package manager 847, a connectivity manager 848, a notification manager 849, a location manager 850, a graphic manager 851, and a security manager 852.

The runtime library 835 may include, for example, a library module that a compiler uses to add new functions through a programming language while the application 870 is executed. The runtime library 835 performs input/output management, memory management, or a function for an arithmetic function.

The application manager 841 manages, for example, a life cycle of at least one of the applications 870. The window manager 842 may manage GUI resources used by a screen of the electronic device. The multimedia manager 843 determines formats required for the reproduction of various media files and performs an encoding or decoding of the media file by using a codec suitable for the corresponding format. The resource manager 844 manages resources such as a source code, a memory, and a storage space of at least one of the applications 870.

The power manager 845 may operate together with a Basic Input/Output System (BIOS) to manage a battery or power and may provide power information required for the operation of the electronic device. The database manager 846 generates, searches for, or changes a database to be used by at least one of the applications 870. The package manager 847 manages the installation or the updating of applications distributed in the form of package file.

The connectivity manager 848 manages wireless connection of, for example, Wi-Fi® or Bluetooth®. The notification manager 849 n displays or notifies of an event such as an arrival message, proximity notification, and the like in such a way that does not disturb a user. The location manager 850 manages location information of the electronic device. The graphic manager 851 manages graphic effects to be provided to a user and user interfaces related to the graphic effects. The security manager 852 provides all security functions required for system security or user authentication. When the electronic device has a call function, the middleware 830 may further include a telephony manager for managing a voice call function or a video call function of the electronic device.

The middleware 830 may include a middleware module for forming a combination of various functions of the aforementioned components. The middleware 830 may provide modules specialized according to types of operating systems in order to provide differentiated functions. Further, the middleware 830 may dynamically remove some of the existing components or add new components.

The API 860 is, for example, a set of API programming functions, and a different configuration thereof may be provided according to an operating system. For example, Android® or iOS® may provide one API set per platform, and Tizen® may provide two or more API sets per platform.

The applications 870 may include, for example, one or more applications which can provide functions such as home 871, dialer 872, SMS/MMS 873, Instant Message (IM) 874, browser 875, camera 876, alarm 877, contacts 878, voice dialer 879, email 880, calendar 881, media player 882, album 883, clock 884, health care (e.g., measure exercise quantity or blood sugar), or environment information (e.g., atmospheric pressure, humidity, or temperature information).

The applications 870 may include an application (“information exchange application”) supporting information exchange between the electronic device (the electronic device 101 and an external electronic device 102 or 104. The information exchange application may include, for example, a notification relay application for transferring predetermined information to an external electronic device or a device management application for managing an external electronic device.

For example, the notification relay application may include a function of transferring, to the external electronic device, notification information generated from other applications of the electronic device 101 (e.g., an SMS/MMS application, an e-mail application, a health management application, or an environmental information application). Further, the notification relay application may receive notification information from, for example, a control device and may provide the received notification information to the user. The device management application may manage (for e.g., install, delete, or update), for example, a function for at least a part of the external electronic device communicating with the electronic device (e.g., turning on/off the external electronic device itself (or some elements thereof) or adjusting brightness (or resolution) of a display), applications executed in the external electronic device, or services provided from the external electronic device (e.g., a telephone call service or a message service).

The applications 870 may include an application (e.g., health management application) designated according to attributes of the external electronic device (e.g., attributes of the electronic device, such as the type of electronic device which corresponds to a mobile medical device). The applications 870 may include an application received from the external electronic devices (e.g., the server 106 or the electronic devices 102, 104). The applications 870 may include a preloaded application or a third party application which can be downloaded from the server 106. The names of the components of the program module 810 according to the embodiment illustrated in FIG. 3 may vary according to the type of operating system.

At least some of the programming module 810 may be implemented by software, firmware, hardware, or a combination of two or more of these components. At least some of the programming module 810 may be implemented (executed) by, for example, the processor (the application program). At least some of the programming module 310 may include, for example, a module, program, routine, sets of instructions, or process for performing one or more functions.

According to various embodiments, at least a portion of an apparatus (e.g., modules or functions thereof) or a method (e.g., operations) according to the present disclosure may be implemented as an instruction stored in a non-transitory computer-readable storage media, for example, in the form of a programming module. An instruction, when executed by one or more processors (e.g., the processor 120), may allow the one or more processors to perform a function corresponding to the instruction. The computer-readable storage media may be, for example, the memory 130. At least a portion of a programming module may be implemented (e.g., executed) by, for example, the processor 120. At least a portion of the programming module may include, for example, a module, a program, a routine, sets of instructions, or a process, etc. for performing one or more functions.

The non-transitory computer-readable storage media may include a hard disk, a magnetic media such as a floppy disk and a magnetic tape, Compact Disc Read Only Memory (CD-ROM), optical media such as Digital Video Disc (DVD), magneto-optical media such as a floptical disk, and a hardware device specially configured for storing and performing a program instruction (e.g., a programming module) such as Read Only Memory (ROM), Random Access Memory (RAM), a flash memory, etc. Also, the program instruction may include not only a machine language code generated by a compiler but also a high-level language code executable by a computer using an interpreter, etc. The above-described hardware device may be configured to operate as one or more software modules in order to perform an operation of the present disclosure, and vice versa.

A terminology “module” used for the present disclosure may mean, for example, a unit including a combination of one or two or more among a hardware, a software, or a firmware. A “module” may be interchangeably used with a terminology such as a unit, a logic, a logical block, a component, or a circuit, etc. A “module” may be a minimum unit of an integrally configured part or a portion thereof. A “module” may be a minimum unit performing one or more functions or a portion thereof. A “module” may be mechanically or electronically implemented. For example, a “module” according to the present disclosure may include at least one of an application-specific integrated circuit (ASIC) chip, a field-programmable gate arrays (FPGAs), or a programmable-logic device which are known, or to be developed in the future, and performing certain operations.

A module or programming module according to various exemplary embodiments may include at least one or more of the aforementioned constituent elements, or omit some of the aforementioned constituent elements, or include additional other constituent elements. Operations carried out by the module, the programming module or the other constituent elements according to various exemplary embodiments may be executed in a sequential, parallel, iterative or heuristic method. Also, some operations may be executed in different order or may be omitted, or other operations may be added.

And, an exemplary embodiment disclosed in the present document is suggested for the explanation and understanding of a disclosed technical content, and does not limit the scope of the present disclosure. Accordingly, it should be understood that the scope of the present disclosure includes all changes based on the technological spirit of the present disclosure or various other exemplary embodiments.

Methods according to exemplary embodiments disclosed in the claims and/or specification of the present disclosure may be implemented in a form of hardware, software, or a combination of hardware and software.

If the methods are implemented by software, a computer-readable storage medium storing one or more programs (i.e., software modules) may be provided. The one or more programs stored in the computer-readable storage medium are configured to be executed by one or more processors within an electronic device. The one or more programs may include instructions for enabling the electronic device to execute the methods according to the exemplary embodiments mentioned in the claims and/or specification of the present disclosure.

These programs (i.e., software modules, software) may be stored in a Random Access Memory (RAM), a nonvolatile memory including a flash memory, a Read Only Memory (ROM), an Electrically Erasable Programmable ROM (EEPROM), a magnetic disk storage device, a Compact Disk Read Only Memory (CD-ROM), a Digital Video Disc (DVD) or an optical storage device of other form, and a magnetic cassette. Or, the programs may be stored in a memory constructed by a combination of some or all of them. Also, each constructed memory may be included in plural as well.

Also, the programs may be stored in an attachable storage device accessible through a communication network such as the Internet, an intranet, a Local Area Network (LAN), a Wireless LAN (WLAN) and a Storage Area Network (SAN) or a communication network constructed in a combination of them. This storage device may access a device performing an exemplary embodiment of the present disclosure through an external port. Also, a separate storage device on the communication network may access the device performing the exemplary embodiment of the present disclosure as well.

In the aforementioned concrete exemplary embodiments of the present disclosure, constituent elements included in the disclosure have been expressed in the singular number or the plural number in accordance to the proposed concrete exemplary embodiments. But, for description convenience, the expression of the singular number or plural number is merely selected suitable to a proposed situation, and the present disclosure is not limited to singular or plural constituent elements. Even the constituent element expressed in the plural number may be constructed in the singular number, or even the constituent element expressed in the singular number may be constructed in the plural number.

While a concrete exemplary embodiment has been shown and described in a detailed description of the present disclosure, various changes may be made therein without departing from the scope of the present disclosure. Therefore, the scope of the present disclosure should not be limited and defined by the described exemplary embodiments and should be defined by not only claims described below but also equivalents to the claims.

What is claimed is:

1. A first electronic device comprising:
a communication unit configured to receive preference information about each of a plurality of sub-contents constituting contents from a second electronic device; and
a display unit configured to display the preference information for each of the plurality of sub-contents.

2. The device of claim 1, wherein the display unit is configured to display a color matching with the preference information for each of the plurality of sub-contents.

3. The device of claim 2, wherein the display unit is configured to display a position of each of the plurality of sub-contents on a User Interface (UI) for searching the contents, and display a preference information matching with the position of each of the plurality of sub-contents on the UI.

4. The device of claim 2, wherein the display unit is configured to align and display items of the respective plurality of sub-contents whose preference information are displayed.

5. The device of claim 4, wherein the display unit is configured to align and display the items in at least one of a thumbnail form and a list form.

6. The device of claim 1, wherein the contents are contents of a digital magazine, and the plurality of sub-contents are a plurality of pages constituting the digital magazine.

7. The device of claim 1, wherein the contents includes at least one of a video and a sound file, and the plurality of sub-contents are an arbitrarily divided plurality of sections constituting the at least one of a video and a sound file.

8. The device of claim 1, wherein the communication unit is configured to transmit viewing information about each of the plurality of sub-contents, to the second electronic device.

9. A second electronic device comprising:
a reception unit configured to receive viewing information about each of a plurality of sub-contents constituting contents, from at least one first electronic device; and
a transmission unit configured to transmit preference information about each of the plurality of sub-contents, to the at least one first electronic device.

10. The device of claim 9, further comprising a control unit is configured to generate the preference information based on the viewing information.

11. A method of operating a first electronic device, comprising:
receiving preference information about each of a plurality of sub-contents constituting contents, from a second electronic device; and
displaying the preference information for each of the plurality of sub-contents.

12. The method of claim 11, wherein the displaying of the preference information comprises displaying a color matching with the preference information for each of the plurality of sub-contents.

13. The method of claim 11, wherein the displaying of the preference information further comprises:
displaying a position of each of the plurality of sub-contents on a User Interface (UI) for searching the contents; and
displaying a preference information matching with the position of each of the plurality of sub-contents on the UI.

14. The method of claim 11, wherein the displaying of the preference information aligns and displays items of the respective plurality of sub-contents whose preferences information are displayed.

15. The method of claim 14, wherein the displaying of the preference information aligns and displays the items in at least one of a thumbnail form and a list form.

16. The method of claim 11, wherein the contents are contents of a digital magazine, and the plurality of sub-contents are a plurality of pages constituting the digital magazine.

17. The method of claim 11, wherein the contents are at least one of a video and a sound file, and the plurality of sub-contents are an arbitrarily divided plurality of sections constituting the at least one of a video and a sound file.

18. The method of claim 11, further comprising transmitting viewing information about each of the plurality of sub-contents, to the second electronic device.

19. A method of operating a second electronic device, comprising:
receiving viewing information about each of a plurality of sub-contents constituting contents, from at least one first electronic device; and
transmitting preference information about each of the plurality of sub-contents, to the at least one first electronic device.

20. The method of claim 19, further comprising generating the preference information based on the viewing information.
